(19) United States
(12) Patent Application Publication
(10) Pub. No.: US 2002/0181691 A1
(43) Pub. Date: Dec. 5, 2002

(54) PBX remote telephone control system

(75) Inventors: Kory Wade Miller, Snohomish, WA (US); Melody Lee Moore, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Teltone Corporation

(21) Appl. No.: 10/153,233

(22) Filed: May 21, 2002

Related U.S. Application Data
(60) Provisional application No. 60/292,995, filed on May 22, 2001.

(51) Int. Cl. H04M 7/00

(52) U.S. Cl. 379/234; 379/229

(57) ABSTRACT

The present invention provides a way of using a remote telephone (208a, 208b, 208c . . . ) to control a plurality of functions of the exchange (240) of a Private Branch Exchange (PBX) system (201). The PBX system (201) includes a server computer (210) capable of controlling the functionality of the exchange (240). The method includes establishing a communication link (206a, 206b, 206c, . . . and 207) between the remote telephone (208a, 208b, 208c . . . ) and the server computer (210). Communications received from the remote telephone (208a, 208b, 208c . . . ) are processed to identify control commands. Control commands are associated with corresponding functions of the exchange (240) of the PBX system (201). The server computer (210) controls the corresponding functions of the exchange (240) based on the control commands. The control commands may be in the form of DTMF signals or voice signals that form words.

### CROSS REFERENCE TO RELATED APPLICATION

This application claims the benefit of prior U.S. Provisional Patent Application No. 60/292,995, filed on May 22, 2001, priority from the filing date of which is hereby claimed under 35 U.S.C. § 119.

### FIELD OF THE INVENTION

The present invention is related to the field of telecommunications systems and, in particular, to remotely controlling the features of a Private Branch Exchange system.

### BACKGROUND OF THE INVENTION

The Public Switched Telephone Network (PSTN) also known as the Plain Old Telephone Service (POTS) is the commercially owned and governmentally regulated telecommunications network that connects most telephone users. The PSTN includes combinations of exchanges, switches, routers, computer networks and other typical telephone communication system components that route network telephone calls and data transmissions across the network.

Private Branch Exchange (PBX) systems are private telecommunications networks. For example, offices, hospitals, hotels, and arenas may include a PBX system that connects many of the telephone and/or computer users of the building. Users connected to the PBX system via local lines are called local users. The PBX system may be connected to the PSTN so that remote users (i.e., users not connected to the PBX) may be connected to local users within the PBX system. A PBX system offers cost savings because many local users may share a predetermined number of external (PSTN) connections.

A PBX system includes multiple telephones referred to as local telephones. Generally, one local telephone is assigned to one local user, although not necessarily. In some cases, multiple local telephones are assigned to a single user. In other cases, multiple users are assigned to a single local telephone. Each local telephone is connected by a local line to an exchange. Thus, the typical PBX system includes multiple local lines that are connected to an exchange. Some PBX systems include multiple interconnected exchanges, routers, and other switches. Further, each exchange may be connected to one or more computing devices, such as a server computer, that are programmed to control the functions, such as call routing and switching, of the exchange. In addition, the server computer may be connected through computer networking technology to other computers.

PBX systems offer many features to local users such as answering incoming calls, transferring calls, muting calls, conferencing calls, holding calls, providing voice mail services, forwarding calls, making calls, disconnecting calls, etc. In the past, remote users were unable to access and use these features. For example, remote users could not invoke even simple features like voice mail services.

More recently, devices and methods have been developed enabling remote users to access many of the features of the PBX system. Particularly, methods have been developed that allow remote users to transmit commands to the PBX system including commands that instruct the PBX system how to handle incoming calls. These methods typically require the use of a computing device to transmit control commands to the PBX system. However, it is often not practical for remote users to access the features of the PBX system with a computing device. If, for example, the remote user is traveling or otherwise unable to access a computer, that remote user is unable to access the features of the PBX system.

Therefore, a need exists for improved ways of remotely controlling a PBX system. In particular, a need exists for ways of remotely controlling a PBX system that do not involve the use of a computing device.

### SUMMARY OF THE INVENTION

The present invention provides a method of using a remote telephone to control a plurality of functions of a Private Branch Exchange (PBX) system. The PBX system is coupled to or includes an embedded server computer capable of controlling the functionality of the PBX system. The method includes establishing a voice communication link between the remote telephone and the server computer. The voice communication link is established by connecting the remote telephone and the server computer across the PSTN. Communications received from the remote telephone include at least one control command associated with a corresponding function of the PBX system controlled by the server computer. The server computer controls the corresponding functions of the PBX system based on received control commands.

Control commands include Dual Tone Multi Frequency (DTMF) signals generated by the actuation of the “push-buttons” on the remote telephone (or in some other manner, such as a hand-held form generator) and/or voice commands. In embodiments using voice commands, processing voice communications for control commands includes monitoring the voice communications for a plurality of predetermined voice commands. The predetermined voice commands are associated with corresponding control commands.

A computer-readable medium and system capable of performing actions generally consistent with the method described above represent further aspects of the present invention.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial representation of the PSTN telecommunication system including connections to PBX systems including a PBX system formed in accordance with this invention;

FIG. 2 is a block diagram of a general purpose computer system suitable for forming the server computer included in the PBX system formed in accordance with the invention shown in FIG. 1;

FIG. 3 is a more detailed pictorial representation of a PBX system implementing the present invention;

FIG. 4 is a more detailed representation of an alternate embodiment of a PBX system implementing the invention, specifically an embodiment that includes a speech recognition server computer;

FIG. 5 is a flow chart showing the operation of the autoclient module running on the server computer shown in FIGS. 3 and 4;

FIG. 6 is a flow chart of an authenticate user ID process suitable for use in the flow diagram shown in FIG. 5;

FIG. 7 is a flow chart of the authenticate password process suitable for use in the flow diagram shown in FIG. 5;

FIG. 8 is a flow chart of the process for determining if a user has permission to use voice commands;

FIG. 9 is an exemplary screen shot of a user interface suitable for use in implementing the present invention;

FIG. 10 is an exemplary pictorial representation of the process employed by the present invention to establish a communication path between a server computer and a speech recognition server computer;

FIG. 11 is an exemplary pictorial representation of the process employed by the present invention to initiate a prompting session; and

FIG. 12 is an exemplary pictorial representation of the process employed by the present invention to control a prompting session between a user and a speech recognition server computer.

### DETAILED DESCRIPTION OF THE PREFERRED EMBODIMENT

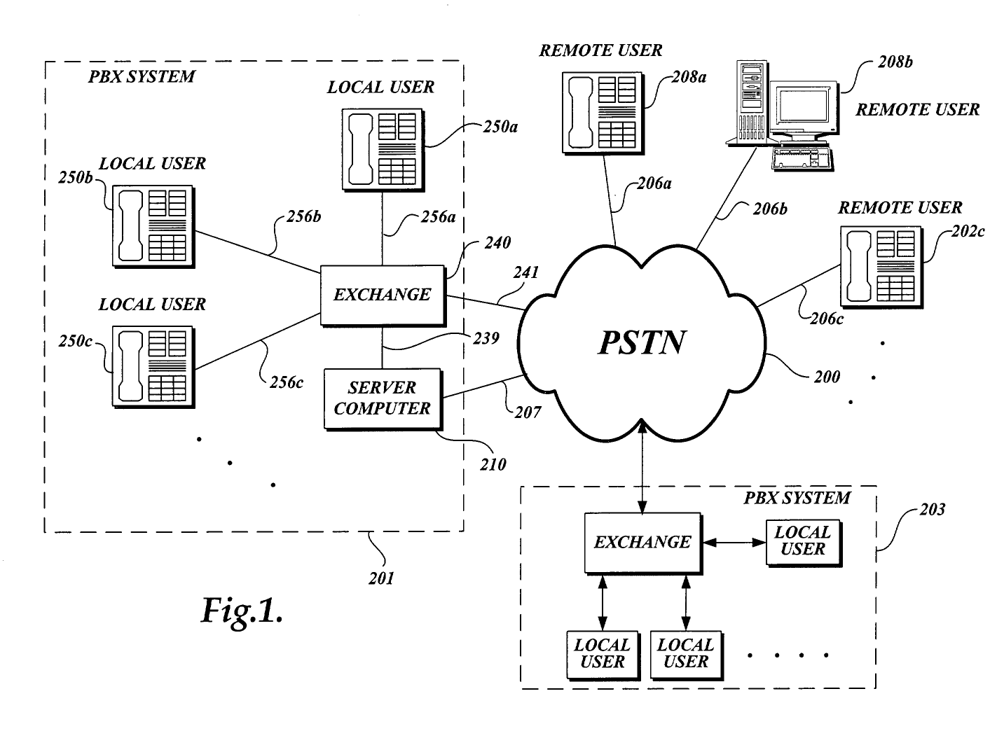

The present invention provides a way for a remote user to control a PBX system from a remote telephone, i.e., a telephone not directly connected to the exchange of the PBX system. The method uses the remote telephone to transmit control commands to the PBX system. To understand better the invention, an exemplary, extremely simplified, telecommunications system is illustrated in FIG. 1.

FIG. 1 illustrates an exemplary architecture of a networked communication system including a PSTN and exemplary PBX systems (one employing the invention) that includes voice and data connections between various telephones and computer systems. Cloud 200 represents the PSTN. The interconnections to and between the components of the PSTN 200 may include cable such as copper and fiber optic lines, wireless, such as cellular, microwave or satellite, or any other suitable interconnection media.

Many components and devices may be connected to the PSTN 200, including PBX systems, telephones, computing devices, and other typical telecommunications components. As noted above, these components may be connected by any method known in the art such as wired cable connections, including copper wire and fiber optic cable, and wireless connections, including cellular, microwave and satellite. While FIG. 1 depicts only two PBX systems, 201 and 203, it is to be understood that many more PBX systems may be connected to the PSTN. Further, while FIG. 1 depicts only three remote users connected to the PSTN, 208a, 208b, 208c . . . , it is likewise to be understood that these are supersensitive and that in actual practice many more remote users are connected to a conventional PSTN. Each remote user, 208a, 208b, 208c . . . is connected to the PSTN via communication links 206a, 206b, 206c . . . , respectively. The remote users 208a, 208b, 208c . . . may take any suitable form including a standard telephone (exemplified by remote users 208a, 208c) connected by standard telephone connection and a computing device (exemplified by remote user 208b) connected by hardware and software components capable of transferring information across the PSTN 200 and wireless devices (not shown).

Referring to FIG. 1, several components of one of the PBX systems 201 (which embodies the present invention) are illustrated in more detail and will now be described. The components of the other PBX system 203 are only shown in block form and in less detail. The PBX system 201 embodying the present invention includes an exchange 240 and a server computer 210. The exchange 240 is a conventional PBX exchange capable of handling typical telephone communication protocols and interfaces. The exchange 240 is coupled to a server computer 210 (or multiple server computers) by a communication link 239. The communication link 239 may be formed by any suitable telecommunications link well known in the art. Preferably, the connection link is a hard wired link. The exchange 240 is capable of establishing a connection with any telephone communication device connected to the exchange, diagrammatically shown as local users 250a, 250b, 250c . . . via communication links 256a, 256b, 256c . . . Any number of telephone communication devices up to the capacity of the exchange can be coupled to the exchange 240. While depicted as telephones, the local user telephone communication devices can take other forms such as a personal computers with telephone communication capabilities. Communication links 256a, 256b, 256c . . . may be any standard telecommunications links both wired and wireless.

The PBX system 201 has at least two connections to the PSTN 200. First, the exchange 240 is connected to the PSTN 200 in a conventional manner via an exchange communication link 241. The exchange communication link 241 allows the exchange 240 to establish connections between the local users 250a, 250b, 250c . . . of the PBX system 201 and telephone communication devices connected to the PSTN 200 represented diagramatically by remote users 208a, 208b, 208c . . . , and the local users of the other PBX systems 203. Second, the server computer 210 is connected to the PSTN 200 via a server communication link 207 that is more fully described below. The exchange and server communication links 207 and 241 may take the form of any suitable communication link of the type discussed above. Preferably, the server communication link 207 employs analog loopstart or T1 winkstart technologies.

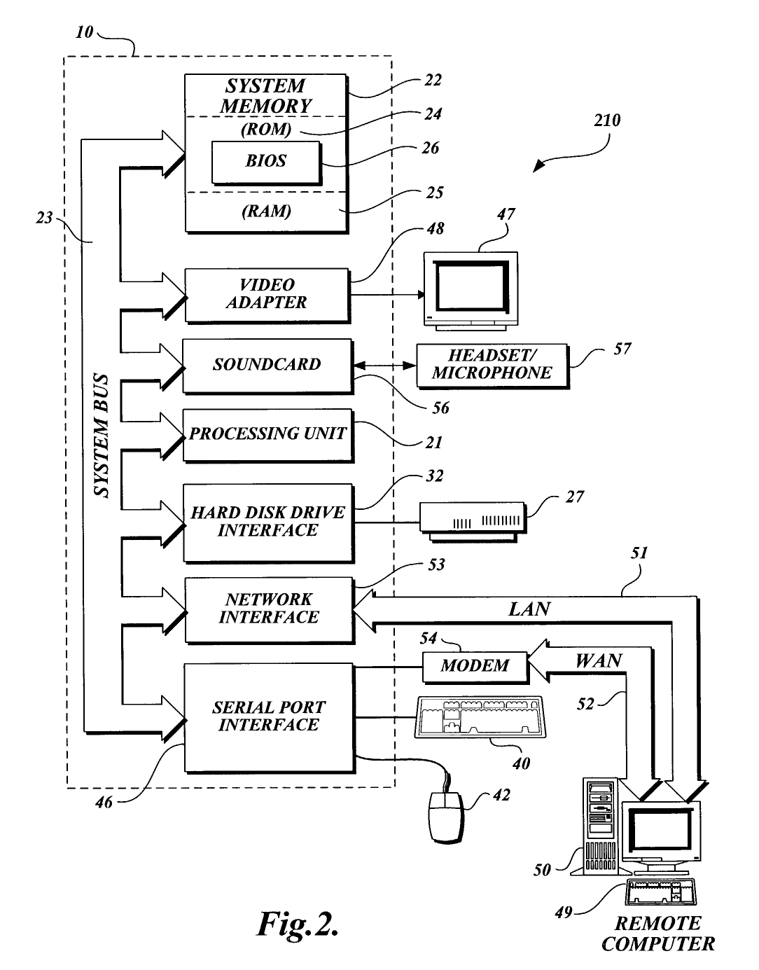

FIG. 2 illustrates an exemplary computer system suitable for forming the server computer 210. FIG. 2 and the following discussion are intended to provide a brief, general description of a suitable computing environment in which aspects of the invention may be implemented. Although not required, aspects of the invention will be described in the general context of computer-executable instructions, such as program modules, being executed by a personal computer. Generally, program modules include routines, programs, objects, components, data structures, etc., that perform particular tasks or implement particular abstract data types. Moreover, those skilled in the art will appreciate that aspects of the invention may be practiced with other computer system configurations.

The exemplary computer system shown in FIG. 2 includes a general purpose computing device in the form of a conventional personal computer 10, including a processing unit 21, a system memory 22, and a system bus 23 that couples various system components including the system memory to the processing unit 21. The system memory includes read only memory (ROM) 24 and random access memory (RAM) 25. A basic input/output system (BIOS) 26, containing the basic routines that help to transfer information between elements within the personal computer 10, such as during start-up, is stored in ROM 24. The system bus 23 may be any of several types of bus structures including a memory bus or memory controller, a peripheral bus, and a local bus using any of a variety of bus architectures. The personal computer 10 further includes a hard disk drive 27 for reading from and writing to a hard disk, not shown. The hard disk drive 27 is connected to the system bus 23 by a hard disk drive interface 32.

A number of program modules may be stored on the hard disk, including an operating system, one or more application programs, other program modules, and program data. A user may enter commands and information into the personal computer 10 through input devices such as a keyboard 40 and pointing device 42. Other input devices, such as a microphone (not shown), can also be used. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. A headset and microphone 57 are also connected to the system bus 23 via an interface, such as a sound card 56. In addition to the monitor, headset and microphone, personal computers typically include other peripheral output devices (not shown), such as printers, speakers, scanners, etc.

The personal computer 10 may operate in a networked environment using logical connections to one or more remote computers, such as remote computer 49. The remote computer 49 may be another personal computer, a server, a router, a network PC, a peer device or other common network node, and typically includes many or all of the elements described above relative to the personal computer 10, although only a memory storage device 50 has been illustrated in FIG. 2. The logical connections depicted in FIG. 2 include a local area network (LAN) 51 and a wide area network (WAN) 52. Such networking environments are commonplace in offices, enterprise-wide computer networks, intranets and the Internet. As depicted in FIG. 2, the remote computer 49 can communicate with the personal computer 20 via the local area network 51 or via the wide area network 52.

When used in a LAN networking environment, the personal computer 10 is connected to the local network 51 through a network interface or adapter 53. When used in a WAN networking environment, the personal computer 10 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 10, or portions thereof, may be stored in the remote memory storage device. It will be appreciated that the network connections shown are exemplary and other means of establishing a communications link between the computers may be used.

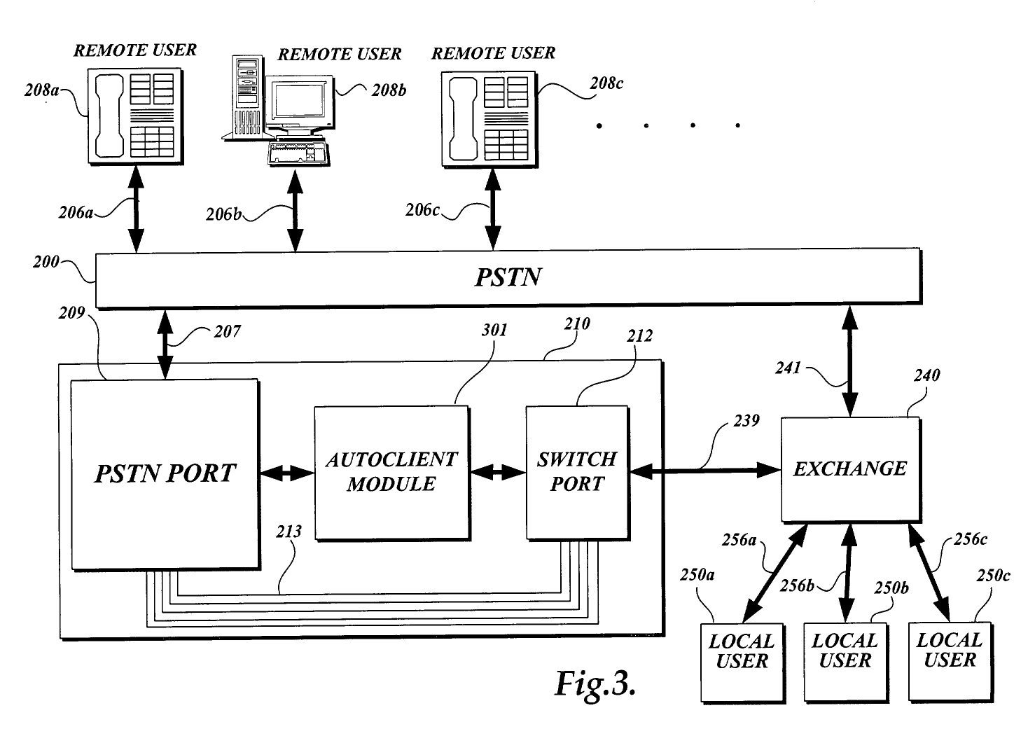

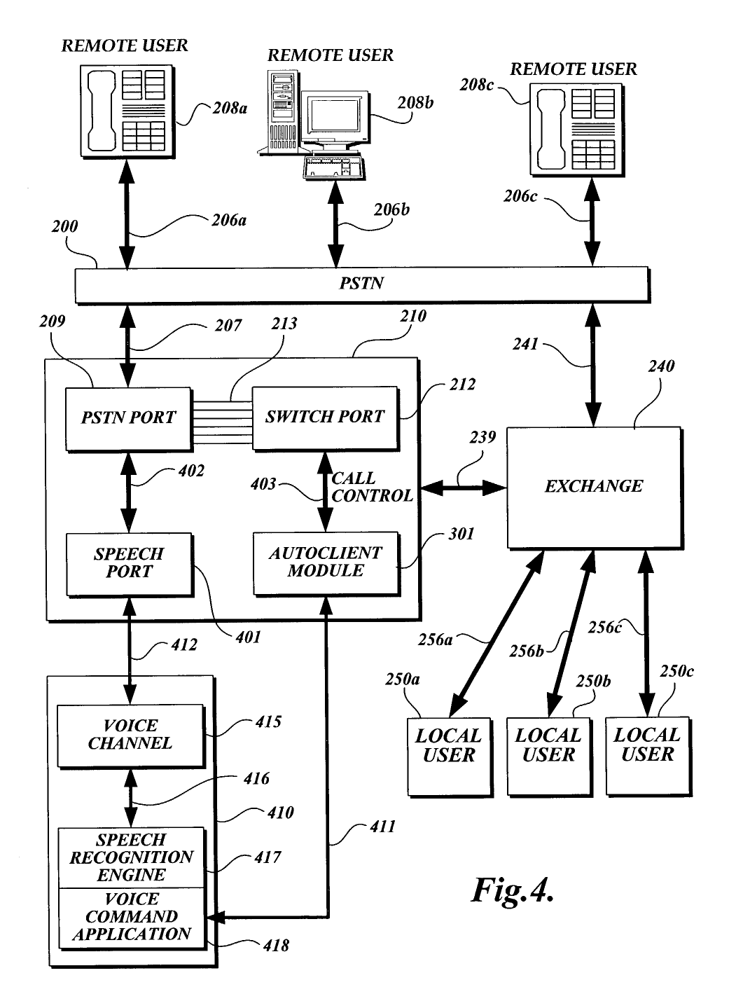

Referring to FIG. 3, the server computer 210 and its connection with the exchange 240 and the PSTN 200 will now be described. Preferably, the server computer 210 is a computing device generally consistent with the computing device 10 illustrated in FIG. 2 and described above. In addition to the components depicted in FIG. 2, the server computer 210 also includes a PSTN port 209, a switch port 212, a system bus 213, and an autoclient module 301. In an alternate embodiment (depicted in FIG. 4 and described below), the server computer 210 also includes a speech port 401 connected to a voice recognition device 410. The voice recognition device 410 may be a programmed general purpose computing device of the type illustrated in FIG. 2 and discussed above, or a dedicated computing device, including a computing device with embedded logic.

Preferably, the PSTN port 209 is formed by one or more computer cards or boards such as Natural Microsystems (NMS) boards or other hardware with similar PSTN portal capabilities. Also, preferably, the PSTN port 209 includes a plurality of both inbound and outbound ports. In one actual embodiment of the invention, the PSTN port 209 includes 96 ports. If desired, additional server computers 210 may be included in the PBX system to provide additional ports. The ports allow bidirectional voice communication to take place between the server computer 210 and remote users 208a, 208b, 208c . . . connected to PSTN 200. The ports of the PSTN port 209 may be dedicated, shared, or pooled in relation to the remote users. Dedicated ports are assigned or dedicated to a single remote user. Shared ports are available for use by two or more remote users. Pooled ports may be used by any remote user. Each port may be configured to only receive inbound signals, only transmit outbound signals, or both receive inbound signals and transmit outbound signals.

Sending control signals to the server computer 210 requires only inbound ports. However, prompting a user requires outbound capabilities. In one actual embodiment of the invention, remote users call the server computer 210 by dialing a telephone number associated with one or more ports having inbound capabilities. If the telephone number is associated with more than one port, a switch or exchange (not separately shown) directs each inbound call to one of the pooled ports. Once an inbound call has been received by a port configured to receive inbound calls, the identity of the caller (remote user) is authenticated by the autoclient module 301 (described below).

Outbound ports of the PSTN port 209 are used to place calls to remote users 208a, 208b, 208c . . . Under predetermined circumstances the server computer 210 is directed to place calls via the PSTN port 209 to a remote user 208a, 208b, 208c . . . Control commands sent by a remote user 208a, 208b, 208c . . . to the server computer 210 direct the server computer 210 to program the functions of the exchange in the same way local users can program the functions of the exchange. Depending on the nature of the exchange, such functions include, but are not limited to: answering incoming calls, transferring calls, muting calls, conferencing calls, holding calls, providing voice mail services, forwarding calls, making calls, disconnecting calls, etc.

A system bus 213, which may be formed by the system bus 23 of FIG. 2 or a separate system bus, provides a communication link between the PSTN port 209 and the switch port 212. Preferably, the system bus 213 is a H.100 bus. The switch port 212 is linked by a voice communication link 239 to the exchange 240. This linkage allows voice communications to be routed between the PSTN port 209 and the exchange 240.

The autoclient module 301 communicates with and controls the PSTN 209 and the switch port 212. Preferably, the autoclient module 301 is a software module that forms part of an application program or programs running on the server computer 210. As will be better understood from the following description, the autoclient module functions to extend the functionality of the exchange 240 to remote users 208a, 208b, 208c . . . connected to the PSTN 200. The extended functionality allows remote users 208a, 208b, 208c . . . to control the features and functions of the exchange 240.

In accordance with the present invention, a remote user 208a, 208b, 208c . . . sends control commands to the server computer 210 using only a telephone. The telephone of a remote user herein called a remote telephone is a telephone that does not form part of the PBX system. Remote telephones may be wired telephones or wireless telephones. Remote users 208a, 208b, 208c . . . communicate with other users, both local and remote, through the remote user's connection to the PSTN port 209 of the server computer 210.

Control commands are sent to the server computer 210 by first establishing a connection to the PSTN port 209. Once a call has been received by the PSTN port 209, the autoclient module 301 answers the call. Preferably, the autoclient module 301 authenticates the remote user and determines whether the remote user has permission to enter control commands. If the remote user is allowed to proceed, the commands entered by the remote user in the manner herein described are implemented by the autoclient module 301. If instead of entering commands, the remote user 208 desires to conduct voice communication with another user (local or remote), the autoclient module 301 transfers the voice information over the system bus 213 to the exchange 240 via the switch port 212. Likewise, the autoclient module 301 transfers voice communications received by the switch port 212 to the PSTN port 209 via the system bus 213. Voice signals may take any form known in the art including PCM voice communication signals.

Control commands may be formed by Dual Tone Multi Frequency (DTMF) signals created by pressing the buttons of a push button telephone and/or voice commands. DTMF signals are interpreted by the autoclient module 301. Voice commands may be interpreted by a voice recognition software module running on either the server computer 210 or a separate voice recognition server computer 410. In this regard, the embodiment depicted in FIG. 4 and described below includes a separate voice recognition server computer 410. The separate voice recognition server computer may take the form of suitably programmed general purpose personal computer of the type illustrated in FIG. 2 and described above. Or, as will be readily apparent to those of ordinary skill in the art, the functions of the voice recognition server computer 410 could be included in the server computer 210. Such a configuration also falls within the scope of the present invention.

In one actual embodiment of the invention, the autoclient module 301 processes DTMF control command signals generated separately (e.g., prior to voice communication) or during voice communication between a remote user 208a, 208b, 208c and another party. Communications routed by the server computer 210 between the PSTN and switch ports are monitored by autoclient module 301 for DTMF control command signals. Alternatively, rather than using DTMF signals to provide control commands separately or during voice communication, voice signals can be used to provide control commands separately or during voice communications. In this case, the server computer 210 or the separate speech recognition server computer 410, as the case may be, are programmed to monitor for voice commands and supply them to the autoclient module upon receipt.

FIG. 4 illustrates in greater detail the communication system briefly described above that includes a separate speech recognition server computer 410 and the relation between the separate speech recognition server computer 410 and the autoclient module 301. As was described previously, voice communications received by the PSTN port 209 may be transferred to the switch port 212 via the system bus 213. When the speech recognition server computer 410 is enabled, a local bus switch is activated. Activation of the local bus switch causes the voice communications to also be transmitted via a communication path 402 to a speech port 401 of the server computer 210. The speech port includes hardware and software components well known to those skilled in the art. Preferably the speech port 401 includes a VoIP (voice over Internet protocol) or PSTN port.

The speech port 401, which is included in the server computer 210, forwards the voice communication it receives to the speed recognition server computer 410. More specifically, voice communication is transmitted from the speech port 401 to the speech recognition server computer 410 via a communication link 412. The communication link 412 has simplex or full-duplex capability, as required. A voice channel 415 receives the voice communication transmitted by the server computer 210. The voice channel 415 is generally similar to the speech port 401. The voice channel 415 forwards the voice communication to a speech recognition engine 417 that determines whether the voice communication includes words that match predetermined stored words and word strings. If the voice communication includes any of the predetermined words or word strings, a voice command application 418 generates a command signal that is sent to the autoclient module 301 via a communication link 411. Such command signals cause the autoclient module 301 to send an appropriate command to the switch port 212.

Autoclient

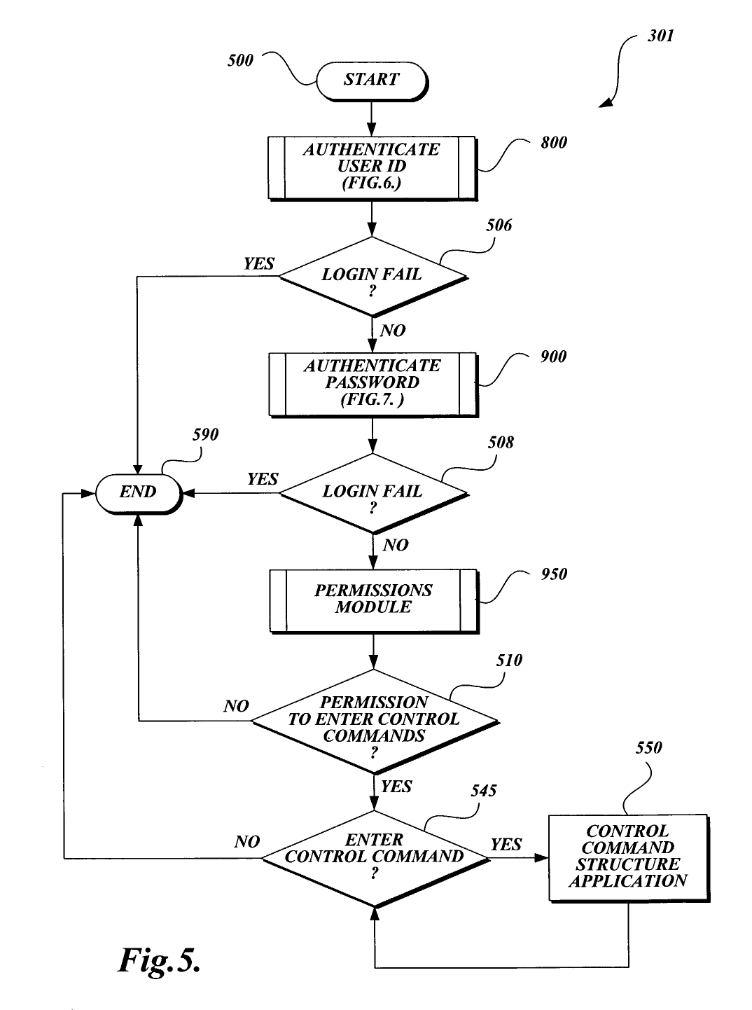

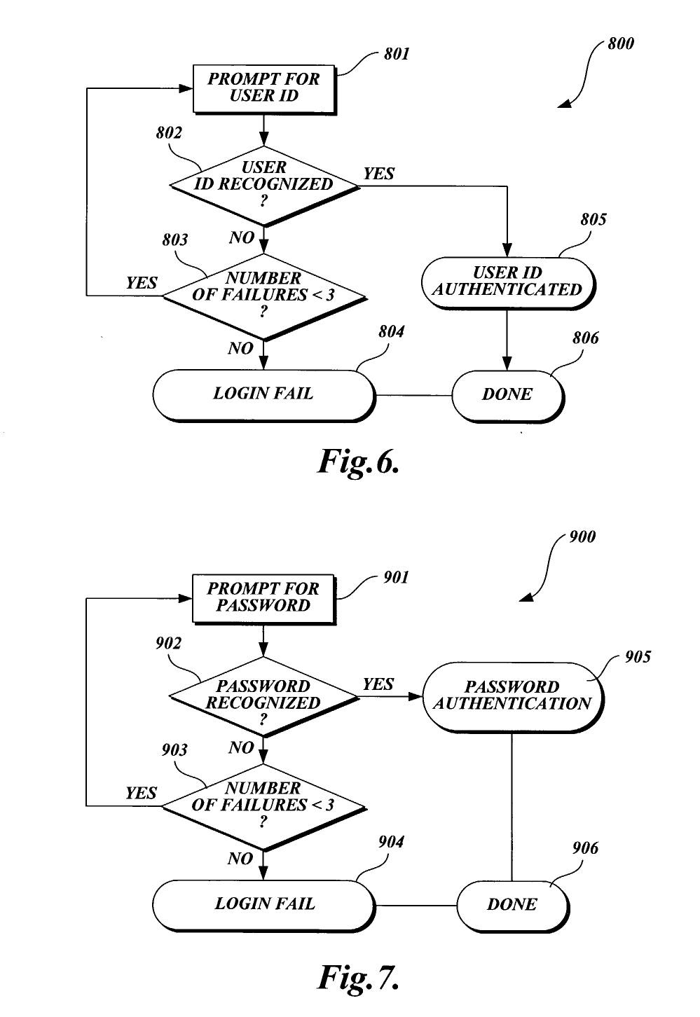

FIG. 5 is a functional flow diagram showing the operation of the autoclient module 301. As discussed above, preferably, prior to entering control commands, a user must be authenticated. Thus, the autoclient module 301 includes an authenticate user ID block 800. FIG. 6 is a flow chart of an exemplary user ID authentication process suitable for accomplishing the functions of the authenticate user ID block 800.

Referring to FIG. 6, when a call is first answered by the autoclient module 301, as shown by block 801, the autoclient module 301 prompts (i.e., asks) the remote user to enter a user ID. Preferably, the remote user is prompted to enter a user ID by playing a sound file that asks the remote user to enter a user ID. If the embodiment of the invention is of the type shown in FIG. 3, the remote user can enter a user ID using the touch tone keypad of a telephone. Alternatively, if the embodiment of the invention is of the type shown in FIG. 4, the remote user can verbally communicate the user ID. At decision block 802, a test is made to determine if the user ID entered by the remote user is recognized by the autoclient module. This is accomplished by the autoclient module comparing the received user ID with a stored list of user IDs. If the user ID is recognized, the user ID is authenticated in block 805. Then the user ID authentication process 800 terminates at block 806. If the user ID is not recognized, as shown by block 803, a test is made to determine if the user has made three unsuccessful attempts to enter a user ID. If the remote user has made three unsuccessful attempts, the user ID authentication process sets a login failed flag and, if desired, notifies the remote user of a login failure. Then, the user ID authentication process ends at block 806. If the remote user has not made three unsuccessful attempts, the user ID authentication process returns to block 801 where the user is again prompted to enter a user ID.

Returning to FIG. 5, after the user ID authentication process 800 is complete, a test is made to determine if the login failed (decision block 506). If the login failed, the autoclient module 301 terminates at block 590. If the login did not fail, the autoclient module 301 authenticates a user password at block 900.

FIG. 7 is a flow chart of an exemplary password authentication process 900. In block 901, the password authentication process prompts the remote user to enter a password. Preferably, the remote user is prompted by playing a sound file that asks the remote user to enter a password. Depending on the type of embodiment of the invention (FIG. 3 or 4) the remote user can enter the password in a manner similar to the manner in which the user ID was entered. At decision block 902, a test is made to determine if the password entered by the remote user is recognized by the autoclient module. This is accomplished by the autoclient module comparing the received password with a stored password associated with the previously recognized user ID. If the password is recognized, the password is authenticated and, then, the password authentication process ends at block 905. If the password is not recognized, a test is made to determine (block 903) if the remote user has made three unsuccessful attempts to enter a password. If the remote user has made three unsuccessful attempts, at block 904 a login failed flag is set and, if desired, the remote user is notified of the login failure. Then the password authentication process ends at block 906. If the remote user has not made three unsuccessful attempts to enter a password, the password authentication process returns to block 901 where the remote user is again prompted to enter a password.

Returning to FIG. 5, after the password authentication process ends, a test is made (decision block 508) to determine if the login process failed. If the login process failed, the autoclient module 301 terminates at block 590. Otherwise, the autoclient module 301 proceeds to a user permission module at block 950.

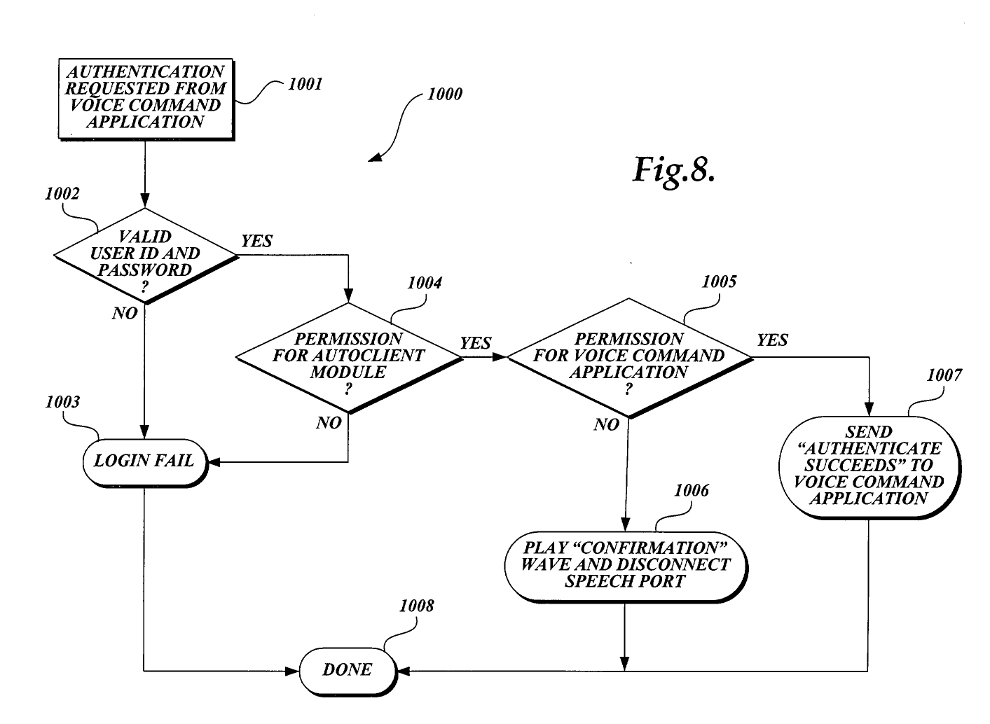

Preferably, the autoclient module 301 can be configured to allow users to enter commands in: 1) DTMF form (FIG. 3), using the push buttons of the user's remote telephone; 2) voice form (FIG. 4); or 3) both forms (FIG. 4). If only in DTMF form, the permission module just checks to determine if the authenticated user ID and password are permitted to use the autoclient module. If the user does not have permission to use the autoclient module, a login failed flag is set. If only in voice form, or if in both forms, the permission module makes a pass through a voice authentication process. An exemplary voice authentication process 1000 is illustrated in FIG. 8 and described next.

At block 1001, the voice authentication process 1000 receives an authentication request from the voice command application 418. Next, at block 1002, a test is made to determine if a valid user ID and password have been entered. This can be accomplished by checking the previously described flags. If either a valid user ID and/or a valid password have not been entered, the login fails at block 1003. Then the process terminates at block 1008. If both a valid user ID and a user password have been entered, the voice authentication process 1000 proceeds to decision block 1004.

At decision block 1004 a test is made to determine if the user has permission to use the autoclient module 301. If, based on the validated user ID and password, the user does not have permission to use the autoclient module 301, the permission login fails at block 1003 and the process terminates at block 1008.

If the user has permission to use the autoclient module 301, the voice authentication process 1000 proceeds to decision block 1005, where a test is made to determine if the user has permission to use the voice command application 418. If the user is not permitted to use voice command application 418, a suitable flag is set and the user is notified that the user is not permitted to use voice commands (block 1006). Then the process terminates at (block 1008). If the user is permitted to use the voice command application 418, at block 1007 a suitable flag is set and the user is notified that the authentication was successful and that the user may use voice commands. The voice authentication process then terminates at block 1008.

Returning to FIG. 5, after the pass through the permissions module 950 is complete, a test is made at decision block 510 to determine if the user has permission to enter control commands either via DTMF signals, voice signals, or both. If the user has permission to enter control commands (DTMF or voice), at decision block 545, a test is made to determine if the user has generated a control command prefix indicating that a control command is forthcoming. In the case of a DTMF only embodiment of the invention (FIG. 3), the control command prefix may be the DTMF signal generated by the pressing of a particular telephone push button, such as the # key. In the case of a voice only or combination voice and DTMF embodiments of the invention, the control command prefix may be a hot word, such as “program.” If the user has entered a control command prefix, the control command structure application 550 is accessed. The control command structure application 550 (discussed below) includes all of the logic required to process voice communications to locate control commands. The control command structure application 550 also includes all of the logic required to execute control commands, i.e., program the exchange in accordance with the control commands. After each control command is executed, the autoclient module loops, back to decision block 545 and waits for another control command prefix. When the user has finished entering commands, the application terminates at block 590. While not shown, a wait loop is entered for a predetermined period of time before the autoclient module process terminates.

The control command structure application 550 of the autoclient module 301 programs the exchange 240. Preferably, any exchange functions that are programmable by a local user telephone 250a, 250b, 250c . . . are programmable from a remote user telephone 208a, 208b, 208c . . . , via the autoclient module. For example, the control command structure application 550 can configure the exchange 240 to route calls directed to a telephone of a local user 250a, 250b, 250c . . . to another telephone—either the telephone of a remote user 208a, 208b, 208c . . . or a different local user telephone. Thus, a user can enter control commands from a remote telephone directing the autoclient module 301 to forward calls intended for the user's local telephone to a remote telephone when the user is “away from the office.” Therefore, a call to the user received at the exchange 240 will be routed to the PSTN port 209 via the switch port 212 and system bus 213. The PSTN port 209 will then route the call to the designated remote telephone. The user will appear to the caller 202 as if the user 208 were using a local telephone. Calls from other local user telephones connected to the exchange 240 will be directed to the remote telephone selected by the user.

Call routing of the type described above may be terminated in several ways. First, the user may communicate a “logout” control command to the control command structure application 550 of the autoclient module 301. Second, the autoclient module 301 may be configured to discontinue call routing upon the occurrence or non-occurrence of specified events. For example, if three or more routed calls are not answered, call routing may be terminated.

In addition to rerouting or transferring calls as described above, the remote telephone being used by the remote user can program any other exchange function normally programmable by a local user telephone, or a predetermined limited number of such functions. As well known to those skilled in the art, such functions include, but are not limited to: answering incoming calls, transferring calls, muting calls, conferencing calls, holding calls, providing voice mail services, forwarding calls, making calls, disconnecting calls, etc.

The control command structure application 550 contains a list or table, such as a hash table of preconfigured control commands and the feature or features activated by entering each control command. Alternatively or in addition, customized control commands that correspond to either preconfigured or custom features may be entered. One actual embodiment of the present invention includes a control command configuration module that allows a remote user to customize control command/feature combinations as well as add and delete such combinations.

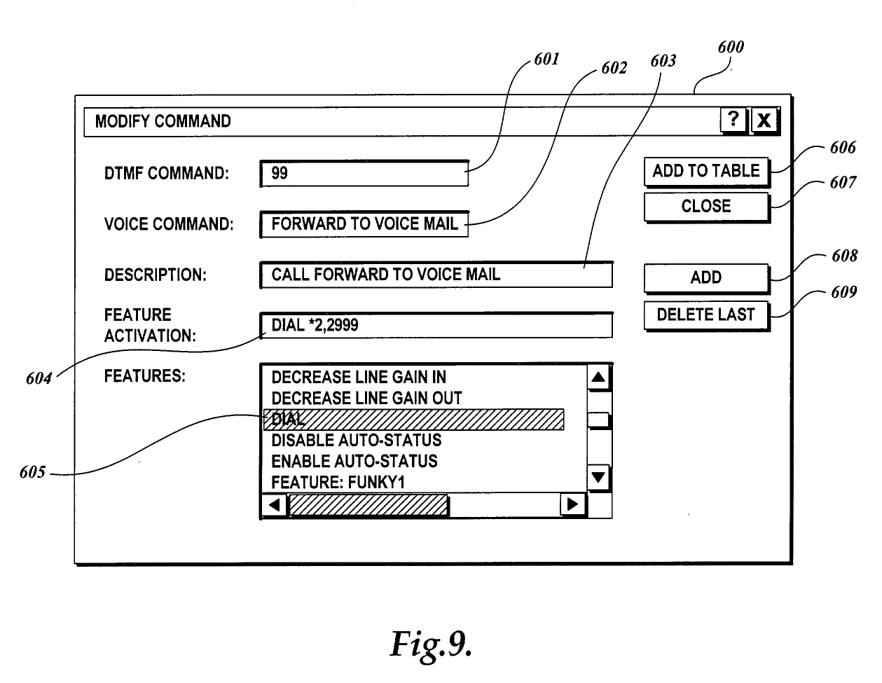

FIG. 9 is an exemplary interface suitable for use in programming the control command structure application 550. The interface includes a control window 600 that includes a DTMF command selection box 601 that allows a user to enter a particular DTMF command. The exemplary control window 600 also includes a voice command selection box 602 that allows a user to enter a particular voice command. A description box 603 is provided to allow a user to maintain notes about the particular control command. A feature activation box 604 contains instructions that are executed when the control command is entered. A feature box 605 identifies the particular feature that a unique control command will invoke if activated. The control window 600 also includes a soft key 606 that allows a user to add a newly created control command to the table of commands, a close soft key 607 that allows a user to close the control window 600, an add soft key 608 that allows a user to add existing control commands to a list of commands and a delete last soft key that allows a user to delete a feature from a list of control commands.

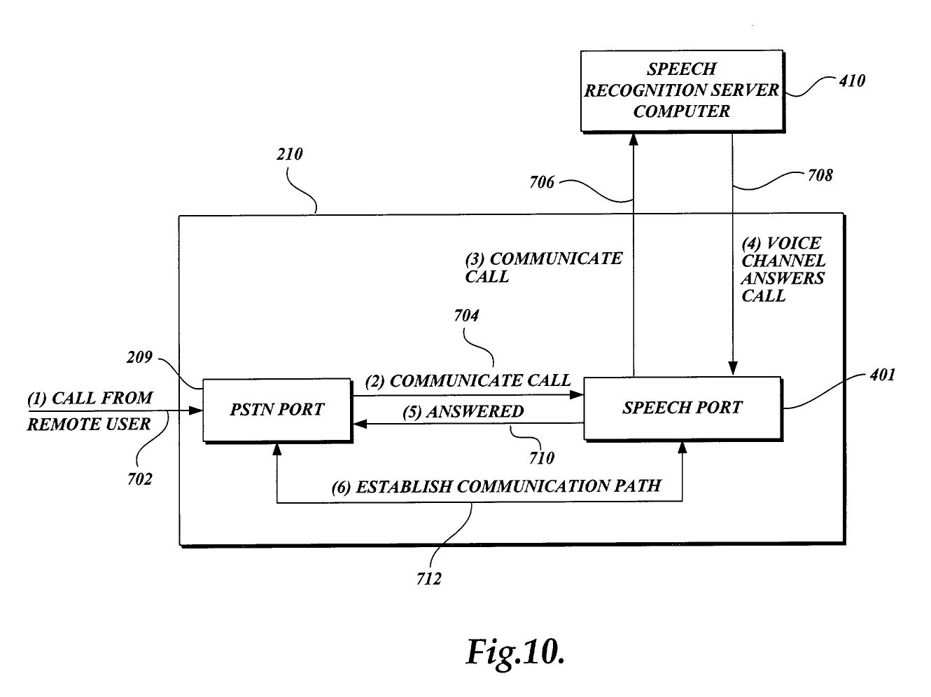

In embodiments of the invention of the type shown in FIG. 4, a communication path is established by the autoclient module 301 between the PSTN port 209 and the speech recognition server computer 410 when a call is initiated by a remote user 208a, 208b, 208c . . . FIG. 10 is a pictorial representation of the steps that occur when such a communication path is established. At step (1), a call 702 is received from the telephone of a remote user 208a, 208b, 208c . . . At step (2), the PSTN port 209 communicates the call 704 to the speech port 401 of the server computer 210. At step (3), the call is communicated 706 to the speech recognition server computer 410. At step (4), the voice channel 415 (see FIG. 4) of the speech recognition server computer 410 answers the call 708 and communicates the answer to the speech port 401. At step (5), the speech port 401 sends a signal to the PSTN port 209 that the call has been answered 710. Upon verification of the call being answered by the speech recognition server computer 410. At step (6), a communication path such as a PCM simplex voice communication path is established 712 between the speech port 401 and the PSTN port 209. As a result, voice communication received at the PSTN port 209 is passed to the speech port 401.

After the communication path between the PSTN port 209 and the speech recognition server computer 410 has been established, the speech recognition engine 417 “listens” for predetermined words. When a predetermined word is identified, as described above, the voice command module 418 (not shown in FIG. 10) may prompt the remote user for additional voice information associated with the predetermined word or may simply wait for additional predetermined words. If the communication path between PSTN port 209 and speech recognition server 410 is only simplex (i.e., unidirectional), the autoclient module 301 may need to establish a full-duplex communication path between PSTN port 209 and the speech recognition server computer 410 in order to prompt the remote user.

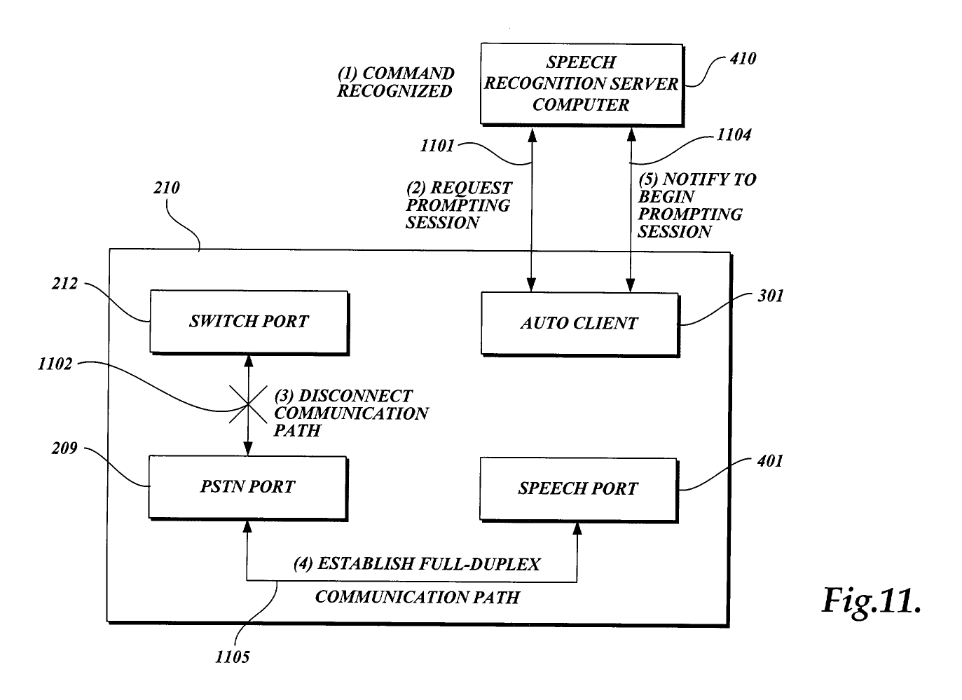

FIG. 11 is a pictorial representation of the steps of an exemplary process for invoking a prompting session. At step (1), a predetermined word (command) is recognized by the speech recognition engine 417 of the speech recognition server computer 410. At step (2), the speech recognition server computer 410 sends a request 1101 to the autoclient module 301 running on server computer 210 to begin a prompting session. At step (3), the server computer 210 disconnects 1102 the communication path (full-duplex) between the PSTN port 209 and the switch port 212. As a result, any voice communications between a remote user 208a, 208b, 208c . . . and other parties connected to the exchange 240 are temporarily interrupted. At step (4), a full-duplex communication link is established 1105 between the PSTN port 209 and the speech port 401. This communication link allows the remote user to hear the speech recognition server computer 410 as well as be heard by the speech recognition server computer 410. At step (5), the autoclient module 301 notifies 1104 the speech recognition server computer 410 to begin the prompting session.

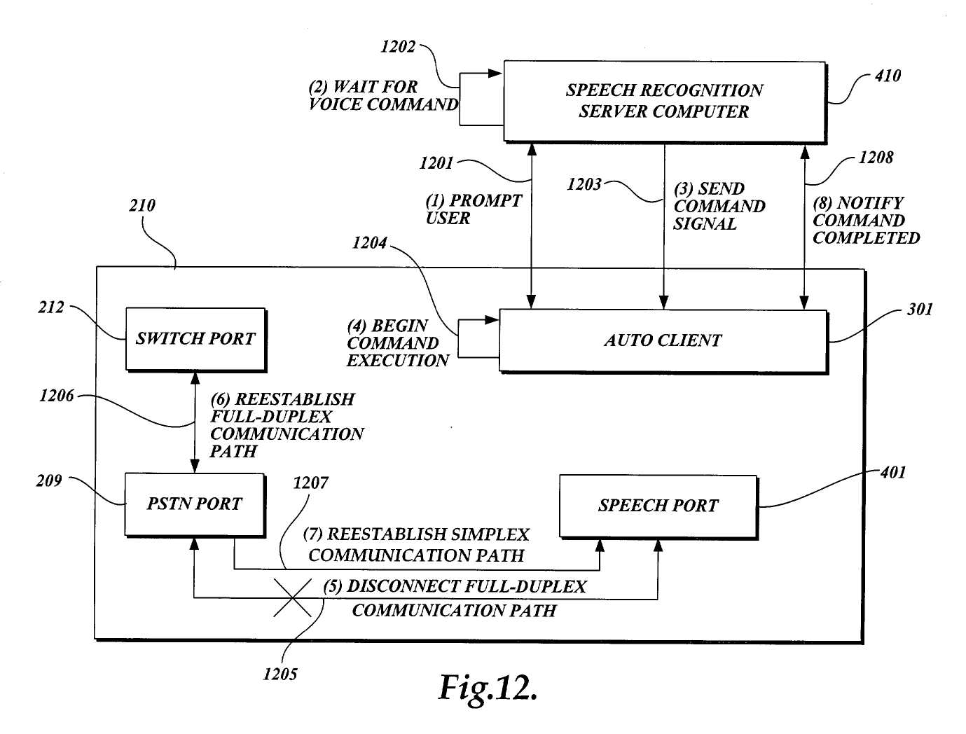

FIG. 12 is a pictorial representation of the steps of an exemplary prompting session between a user and the speech recognition server computer 410. After a prompting session has been established (FIG. 11) at step (1), the voice command application 418 running on the speech recognition server computer 410 prompts 1201 the remote user for a voice command. At step (2), the speech recognition server computer 410 waits 1202 for a voice command to be spoken by the remote user. At this point, the remote user may speak any supported command or commands. A supported command may include a single word such as “hold” or “dial.” Supported commands may also include digits (i.e., “dial 2,2999”). If the command requires digits or other voice command information, the remote user may first speak the command and then immediately speak the digits or other voice command information. Alternatively, the remote user may simply speak the command and wait for the voice command application 418 of the speech recognition server computer 410 to prompt the remote user for additional information. Further, rather than speaking the digits, the digits may be entered using the push buttons of the remote user's telephone.

After the voice command application 418 has received the voice command and any digits or other voice command information at step (3), a command signal is sent 1203 to the control command structure application 550 of the autoclient module 301. At step (4), the control command structure application 550 begins execution of the command 1204 while the speech recognition server computer 410 continues monitoring the voice communication path for additional predetermined words.

At step (5), after the autoclient module 301 receives the command signal from the speech recognition server computer 410, the autoclient module 301 automatically disconnects 1205 the full-duplex communication link established between the speech port 401 and the PSTN port 209 and reestablishes (1206 and 1207) both the full-duplex communication link between the PSTN port 209 and the switch port 212 at step (6) and the simplex communication link between the PSTN port 209 and the speech port 401 at step (7). Alternatively, the remote user may be required to provide a control command indicating that the remote user wishes to re-establish the communication path with switch port 212 before the autoclient module 301 disconnects the full-duplex connection between the PSTN port 209 and the speech port 401 and reestablishes both the full-duplex connection between the PSTN port 209 and the switch port 212 and the simplex communication link between the PSTN port 209 and the speech port 401. After the control command has been executed by the autoclient module 301, at step (8), a notification message is sent 1208 to the speech recognition server computer 410 to indicate the successful completion of the command action.

While a preferred embodiment of the invention has been illustrated and described, it will be appreciated that various changes can be made therein without departing from the spirit and scope of the invention. For example, the login fail texts shown in FIG. 5 could be combined into a single test, or combined with the permission to enter control commands test. Therefore, within the scope of the appended claims, it is to be understood that the invention can be practiced otherwise than as specifically described herein.

The embodiments of the invention in which an exclusive property or privilege is claimed are defined as follows:

1. A computer readable medium having instructions suitable for execution by a server computer for implementing a method of using a telephone not directly connected to the exchange of a Private Branch Exchange (“PBX”) system (a “remote telephone”) to control predetermined functions of the exchange, in addition to the exchange, the PBX system including local telephones and a server computer configured to control the functionality of the exchange, the server computer executable instructions including instructions for:
(a) establishing a communication link between a remote telephone and the server computer;
(b) analyzing communications received from the remote telephone over the communication link to identify control commands;
(c) associating identified control commands with corresponding functions of the exchange; and
(d) controlling the corresponding functions of the exchange in accordance with identified control commands.

2. The computer readable medium of claim 1, wherein said server computer executable instructions also include instructions for sending audible prompts over the voice communication link to the remote telephone.

3. The computer readable medium of claim 1, wherein analyzing communications received from the remote telephone over the communication link to identify control commands comprises monitoring the communications for Dual Tone Multi Frequency (“DTMF”) signals.

4. The computer readable medium of claim 1, wherein analyzing communications received from the remote telephone over the communication link to identify control commands comprises monitoring the communications for predetermined words.

5. The computer readable medium of claim 1, wherein the server computer includes a Public Switched Telephone Network (“PSTN”) port for communicating with remote telephones and a switch port for communicating with said exchange, and wherein said server computer executable instructions include controlling communications between said PSTN port and said switch port.

6. The computer readable medium of claim 1, wherein the functions of the exchange controlled by the server computer comprise functions selected from the group consisting of answering incoming calls, transferring calls, muting calls, conferencing calls, holding calls, providing voice mail services, forwarding calls, making calls, and disconnecting calls.

7. The computer readable medium of claim 1, wherein the functions of the exchange controlled by the server computer include forwarding calls intended for a local telephone of the PBX system to the remote telephone.

8. The computer readable medium of claim 1, wherein said server executable instructions include instructions for establishing a communication link with a speech recognition server computer and forwarding communications received from the remote telephone to the speech recognition server computer.

9. The computer readable medium of claim 8, wherein analyzing communications received from the remote telephone over the communication link to identify control commands comprises monitoring the communications for predetermined words.

10. The computer readable medium of claim 9, wherein the monitoring of the communications to determine predetermined words is performed by the speech recognition server computer.

11. The computer readable medium of claim 10, wherein the predetermined words correspond to control commands.

12. A method of using a telephone not directly connected to the exchange of a Private Branch Exchange (“PBX”) system (a “remote telephone”) to control the operation of a server computer programmed to control the functions of the exchange of the PBX system, in addition to the exchange, the PBX system comprising local telephones and the server computer, the method comprising:
(a) establishing a communication link between a remote telephone and the server computer;
(b) analyzing communications received from the remote telephone over the communication link to identify control commands;
(c) associating identified control commands with corresponding functions of the exchange; and
(d) controlling the corresponding functions of the exchange in accordance with the control commands.

13. The method of claim 12, further comprising sending prompting messages from the server computer over the voice communication link to the remote telephone.

14. The method of claim 12, wherein the control commands are formed by Dual Tone Multi Frequency (“DTMF”) signals.

15. The method of claim 12, wherein the control commands are formed by signals in the form of predetermined words.

16. The method of claim 12, wherein the plurality of functions of the exchange system controlled by the server computer comprise functions selected from the group consisting of answering incoming calls, transferring calls, muting calls, conferencing calls, holding calls, providing voice mail services, forwarding calls, making calls, and disconnecting calls.

17. The method of claim 12, wherein the plurality of functions of the exchange system controlled by the server computer include forwarding calls intended for a local telephone of the PBX system to the remote telephone.

18. The method of claim 12, wherein the method includes establishing a communication link with a speech recognition server computer.

19. The method of claim 18, wherein the speech recognition server computer analyzes communications received from the remote telephone over the voice communication link to identify control commands.

20. The method of claim 19, wherein the control commands are formed by voice signals in the form of predetermined words.

21. The method of claim 20, wherein the predetermined words correspond to control commands.

22. A system for using a remote telephone to control a plurality of functions of a Private Branch Exchange (“PBX”) system via the Public Switched Telephone Network (“PSTN”), the system comprising:
(a) a remote telephone coupled to the PSTN via a PSTN voice communication link; and
(b) a PBX system coupled to the PSTN via a PSTN communication link, the PBX system comprising:
(1) an exchange;
(2) a plurality of local telephones coupled to the exchange; and
(3) a server computer configured to control the functionality of the exchange, the server computer comprising a processing unit, a PSTN communication unit, and a storage medium coupled to the processing unit, the storage medium storing programming code implemented by the processing unit for:
(i) establishing a communication link between the PSTN communication unit and the remote telephone over the PSTN;
(ii) in response to receiving communications from the remote telephone over the voice communication links, processing the received communications to identify control commands;
(iii) associating identified control commands with functions of the exchange; and
(iv) controlling the corresponding functions of the exchange in accordance with said identified control commands.

23. The system of claim 22, including a speech recognition server computer coupled to the server computer.

24. The system of claim 23, wherein processing the communications to identify control commands comprises forwarding communications received by the server computer to the speech recognition server computer.

25. The system of claim 24, wherein the speech recognition server computer comprises:
(a) a processing unit; and
(b) a storage medium coupled to the processing unit, the storage medium storing programming code implemented by the processing unit for:
(1) monitoring forwarded communications for predetermined voice commands;
(2) associating predetermined voice commands with corresponding control commands; and
(3) communicating the corresponding control commands to the server computer.

26. The system of claim 24, wherein controlling the functions of the exchange in accordance with an identified control command comprises forwarding identified control commands from the speech recognition server computer to the server computer.

27. The system of claim 22, wherein the control commands are in the form of Dual Tone Multi Frequency signals.

28. The system of claim 22, wherein the control commands are in the form of voice signals that form words.
